(19) United States
(12) Patent Application Publication
(10) Pub. No.: US 2017/0134823 A1
(43) Pub. Date: May 11, 2017

(54) APPARATUS AND METHOD FOR RECEIVING DIGITAL RADIO BROADCASTING

(71) Applicant: ELECTRONICS AND TELECOMMUNICATIONS RESEARCH INSTITUTE, Daejeon (KR)

(72) Inventors: Bong Ho LEE, Daejeon (KR); Kyu Tae YANG, Daejeon (KR); Hyoung Soo LIM, Daejeon (KR); Nam Ho HUR, Sejong (KR)

(21) Appl. No.: 15/219,111

(22) Filed: Jul. 25, 2016

(30) Foreign Application Priority Data
Nov. 6, 2015 (KR) 10-2015-0155983

(51) Int. Cl. H04N 21/61; H04N 21/258; H04N 21/2362; H04N 21/482

(52) U.S. Cl. CPC H04N 21/6193; H04N 21/6143; H04N 21/4821; H04N 21/25841; H04N 21/2362

(57) ABSTRACT

Provided are an apparatus and a method for receiving digital radio broadcasting. The apparatus according to the present invention includes: a communication unit including a GPS receiving module and a broadcasting receiving module; an output unit receiving and outputting the broadcasting signal through the broadcasting receiving module; and a service linking processing unit requesting service linking information based on current geolocation information received through the GPS receiving module and broadcasting service information included in the broadcasting signal when a receiving sensitivity of the broadcasting signal which is currently received is less than a predetermined reference value and performing service following based on the service linking information provided from a service linking providing server based on the current geolocation information, wherein the service linking information includes information on the same broadcasting service as a broadcasting service which is currently received.

### CROSS-REFERENCE TO RELATED APPLICATIONS

This application claims priority to and the benefit of Korean Patent Application No. 10-2015-0155983 filed in the Korean Intellectual Property Office on Nov. 6, 2015, the entire contents of which are incorporated herein by reference.

### TECHNICAL FIELD

The present invention relates to an apparatus and a method for receiving digital radio broadcasting.

### BACKGROUND ART

With digitalization of an analog radio technology, various additional data services can be provided in addition to a basic audio service and a service such as an electronic program guide (EPG) which is program organization information can be provided.

In general, when a service quality of radio broadcasting, which is received is not good while receiving the radio broadcasting, a user terminal searches neighbor broadcasting service information to perform service following.

However, a quality of a broadcasting service received through the service following may not still be good and in this case, the service following needs to be continuously performed until the broadcasting service quality becomes good.

### SUMMARY OF THE INVENTION

The present invention has been made in an effort to provide an apparatus and a method for receiving digital radio broadcasting, which automatically affiliate and receive a broadcasting service by receiving linkage information of the same broadcasting service or the similar broadcasting service provided from another broadcasting network based on a location of a digital radio broadcasting receiving apparatus when a receiving status of a broadcasting service which is being received is not good at the time of receiving digital radio broadcasting.

The technical objects of the present invention are not limited to the aforementioned technical objects, and other technical objects, which are not mentioned above, will be apparently appreciated by a person having ordinary skill in the art from the following description.

An exemplary embodiment of the present invention provides an apparatus for receiving digital radio broadcasting, including: a communication unit including a GPS receiving module receiving geolocation information from a GPS satellite network and a broadcasting receiving module receiving a broadcasting signal from a broadcasting network; an output unit receiving and outputting the broadcasting signal through the broadcasting receiving module; and a service linking processing unit requesting service linking information based on current geolocation information received through the GPS receiving module and broadcasting service information included in the broadcasting signal when a receiving sensitivity of the broadcasting signal which is currently received is less than a predetermined reference value and performing service following based on the service linking information provided from a service linking providing server based on the current geolocation information.

Herein, the service linking information may include information on the same broadcasting service as a broadcasting service which is currently received.

The service linking information may include information on the same or similar broadcasting service provided through another service channel within the same frequency as the broadcasting service which is currently received.

The service linking information may include information on a broadcasting service which is linkable with the broadcasting service which is currently received among broadcasting services provided from a broadcasting signal having a different frequency from the corresponding broadcasting service.

The service linking information may include at least one of frequency information, ensemble identification information, and service identification information of the corresponding broadcasting service.

The service linking information may be defined in fast information groups (FIG) of a fast information channel (FIC) for digital audio broadcasting (DAB).

The communication unit may further include a communication module transmitting/receiving a signal to/from the service linking providing server through a mobile communication network.

The service linking providing server may build up a database for information on the respective broadcasting services provided from the broadcasting network and search information on a broadcasting service corresponding to the broadcasting service which is currently received from the database based on the geolocation information provided from the service linking processing unit.

The service linking providing server may search service linking information having a highest signal level at a corresponding location among linkage information of the corresponding broadcasting service registered in the database based on the current geolocation information and the broadcasting service information of the digital radio broadcasting receiving apparatus.

The apparatus may further include a storage unit storing the service linking information.

The service linking processing unit may perform the service following based on the service linking information stored in the storage unit when communication connection to the service linking providing server is impossible.

Another exemplary embodiment of the present invention provides a method for receiving digital radio broadcasting, including: receiving a broadcasting signal through a broadcasting receiving module; requesting service linking information to a service linking providing server through a communication module based on current geolocation information received through a GPS receiving module and broadcasting service information included in the broadcasting signal when a receiving sensitivity of the broadcasting signal which is currently received is less than a predetermined reference value; receiving the service linking information corresponding to a broadcasting service which is currently received based on the current geolocation information from the service linking providing server; and performing service following based on the received service linking information, wherein the service linking information includes information on a broadcasting service which is linkable to correspond to the broadcasting service which is currently received.

Further, the method may further include: by the service linking providing server, building up a database for information on respective broadcasting services provided from a broadcasting network; and searching service linking information having a highest signal level based on a corresponding location among linkage information of the corresponding broadcasting service registered in the database based on the current geolocation information and the broadcasting service information of the digital radio broadcasting receiving apparatus, which are received through a communication module.

The method may further include storing the service linking information before the receiving of the broadcasting signal and in the performing of the service following, when communication connection to the service linking providing server is impossible, the service following may be performed based on the service linking information stored in the storing of the service linking information.

According to exemplary embodiments of the present invention, a broadcasting service is automatically linked and received by receiving linkage information of the same broadcasting service or the similar broadcasting service provided from another broadcasting network even though a user does not perform a separate operation or make a separate request when a receiving status of a broadcasting service which is currently received is not good at the time of receiving digital radio broadcasting, thereby providing a continuous broadcasting service to the user.

Further, although related information is not separately searched for broadcasting service linking, the related information can be automatically processed, and as a result, since service following need not be repeatedly performed, an improved service quality can be provided to the user.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a system configuration to which an apparatus for receiving digital radio broadcasting is applied according to the present invention.

FIG. 2 is a diagram illustrating a configuration of the apparatus for receiving digital radio broadcasting according to the present invention.

FIG. 3 is a diagram illustrating detailed driving for a communication unit of FIG. 2.

FIG. 4 is a diagram illustrating a broadcasting network structure applied to the present invention.

FIG. 5 is a diagram illustrating an exemplary embodiment referred for describing service linking information according to the present invention.

FIG. 6 is a diagram illustrating an exemplary embodiment referred for describing a data structure of service linking information according to the present invention.

FIG. 7 is a diagram illustrating an exemplary embodiment referred for describing a data structure of another ensemble information according to the present invention.

FIG. 8 is a diagram illustrating an exemplary embodiment referred for describing a data structure of frequency information according to the present invention.

FIG. 9 is a diagram illustrating an exemplary embodiment implementing service linking information as a database according to the present invention.

FIGS. 10 and 11 are diagrams illustrating an exemplary embodiment referred for describing an operation of the apparatus for receiving digital radio broadcasting according to the present invention.

FIG. 12 is a diagram illustrating an operational flow for a method for receiving digital radio broadcasting according to the present invention.

FIG. 13 is a diagram illustrating a configuration of a computing system to which the apparatus is applied according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

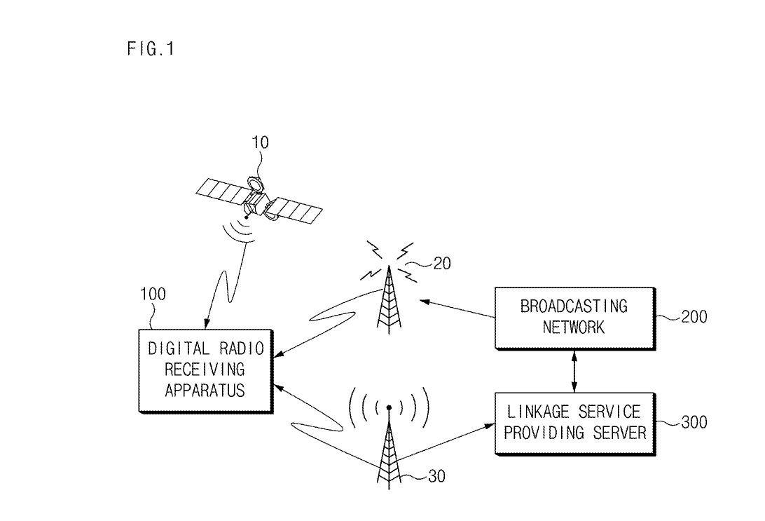

FIG. 1 is a diagram illustrating a system configuration to which an apparatus for receiving digital radio broadcasting is applied according to the present invention.

As illustrated in FIG. 1, the system according to the present invention may include a digital radio broadcasting receiving apparatus 100 and a broadcasting network 200. Further, the system according to the present invention may further include a service linking providing server 300.

In FIG. 1, the digital radio broadcasting receiving apparatus 100 is a terminal that receives a digital radio broadcasting signal from any one broadcasting server located in the broadcasting network 200 through a broadcasting base station 20 and provides the received digital radio broadcasting signal to a user and a digital radio broadcasting receiving module, for example, a DAB module is mounted and either portable terminal which may measure a location, such as a GPS may be adopted.

As one example, the digital radio broadcasting receiving apparatus 100 may include at least one of a smart phone, a tablet personal computer, a mobile phone, a personal digital assistant (PDA), a portable multimedia player (PMP), an MP3 player, a smart watch, and an electronic device provided in a vehicle, for example, a navigation device.

The digital radio broadcasting receiving apparatus 100 may receive a broadcasting signal from the broadcasting network 200 through the digital radio broadcasting receiving module and provide the broadcasting service to the user. In this case, the digital radio broadcasting receiving apparatus 100 may request broadcasting service information to the broadcasting network 200 based on geolocation information verified through a GPS satellite 10.

Further, the digital radio broadcasting receiving apparatus 100 may access a mobile communication network such as 3G, 4G, or LTE through a mobile communication base station 30. In this case, the digital radio broadcasting receiving apparatus 100 may access a service linking providing server through the mobile communication base station 30.

As one example, when a service quality of the received broadcasting signal deteriorates to a predetermined quality or less, the digital radio broadcasting receiving apparatus 100 accesses the service linking providing server 300 through the mobile communication base station 30 to request service linking information corresponding to the broadcasting service which is currently received. In this case, the service linking providing server 300 searches an optimal broadcasting service which may be linked based on geolocation information and the broadcasting service information provided from the digital radio broadcasting receiving apparatus 100 and provides the corresponding service linking information to the digital radio broadcasting receiving apparatus.

Accordingly, the digital radio broadcasting receiving apparatus 100 may receive the broadcasting signal from the broadcasting network 200 based on the service linking information provided from the service linking providing server 300.

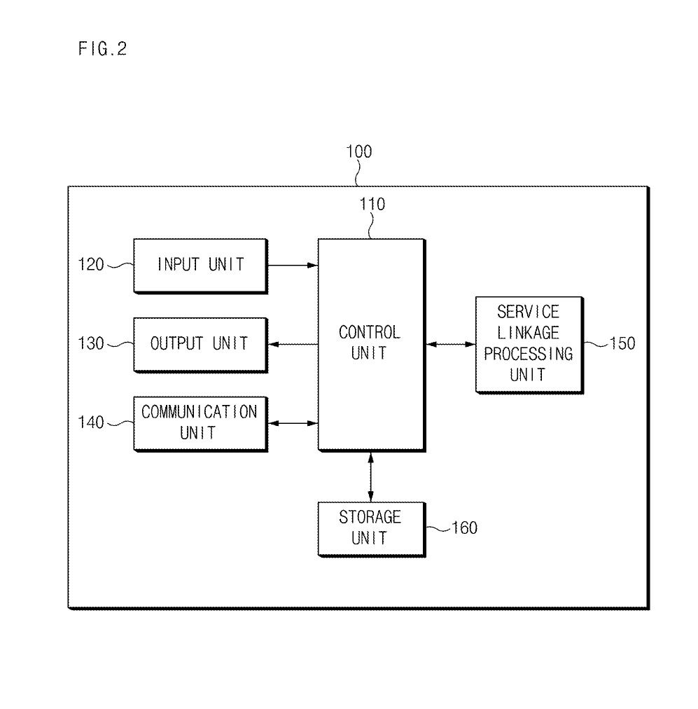

Therefore, a detailed configuration of the digital radio broadcasting receiving apparatus 100 according to the present invention will be described in detail with reference to FIG. 2.

FIG. 2 is a diagram illustrating a configuration of the apparatus for receiving digital radio broadcasting according to the present invention. As illustrated in FIG. 2, the digital radio broadcasting receiving apparatus 100 according to the present invention may include a control unit 110, an input unit 120, an output unit 130, a communication unit 140, and a service linking processing unit 150. Herein, the control unit 110 may process signals transferred among respective units of the digital radio broadcasting receiving apparatus.

The input unit 120 as a means for receiving a control command from the user may correspond to a key button implemented outside the digital radio broadcasting receiving apparatus and also correspond to a soft key implemented on a display. Further, the input unit 120 may be an input means of a form such as a mouse, a joystick, a jog shuttle, or a stylus pen.

The output unit 130 may include a display displaying an operating status and an operating result of the digital radio broadcasting receiving apparatus 100 and include a speaker outputting a voice signal or a buzzer. As one example, the display may display a broadcasting image received through the communication unit 140 and the speaker may output a broadcasting voice.

Herein, when the display includes a sensor that senses a touch operation, the display may be used as an input device in addition to an output device. That is, when touch sensors including a touch film, a touch sheet, a touch pad, and the like are provided in the display, the display may operate as a touch screen and the input unit 120 and the output unit 130 may be implemented to be integrated.

In this case, the display may include at least one of a liquid crystal display (LCD), a thin film transistor-liquid crystal display (TFT LCD), an organic light-emitting diode (OLED), a flexible display, a field emission display (FED), and a 3D display.

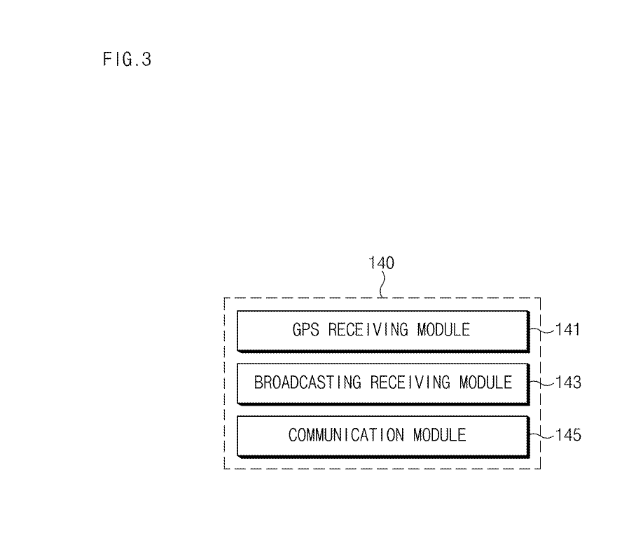

The communication unit 140 serves to transmit/receive a signal for providing the broadcasting service to the user. The communication unit 140 may include a GPS receiving module 141, a broadcasting receiving module 143, and a communication module 145 as illustrated in FIG. 3.

Referring to FIG. 3, the GPS receiving module 141 may receive a GPS signal from a satellite. In this case, the GPS receiving module 141 may obtain geolocation data at a point where the digital radio broadcasting receiving apparatus is located, for example, latitude and longitude data. The geolocation data obtained by the GPS receiving module 141 may be provided to the service linking providing server when the service linking information for the broadcasting service which is received is required. In this case, the service linking providing server may extract the service linking information corresponding to the relevant broadcasting service based on the geolocation data of the digital radio broadcasting receiving apparatus.

The broadcasting receiving module 143 receives and decodes the broadcasting service selected by the user. As one example, the broadcasting receiving module 143 may correspond to a DAB module that receives and decodes a DAB broadcasting signal. An image and/or a voice decoded by the broadcasting receiving module 143 is transferred to the output unit 130 to be output through the display and/or the speaker. Herein, the broadcasting signal received by the broadcasting receiving module 143 may include the broadcasting service information such as the frequency information, ensemble ID information representing information on a specific broadcasting server of the broadcasting network, and service ID information representing information on a broadcasting channel.

Further, the broadcasting receiving module 143 may provide information on the received broadcasting signal to the service linking processing unit 150 in real time or every predetermined period.

The communication module 145 may provide a communication interface with the mobile communication network. The communication module 145 performs communication with the service linking providing server by accessing the mobile communication network such as 3G, 4G, or LTE according to a request from the service linking processing unit 150. In this case, the communication module 145 may be communication-connected with the service linking providing server through a separate authentication procedure for the digital radio broadcasting receiving apparatus and/or the user from the service linking providing server.

When the communication module 145 is communication connected with the service linking providing server, the communication module 145 may transmit a message configured by the service linking processing unit 150 to the service linking providing server and receive the service linking information as a response thereto.

The service linking processing unit 150 may recognize a situation in which service linking is required by periodically checking a receiving sensitivity for the broadcasting signal based on the information of the broadcasting signal provided from the broadcasting receiving module 143.

As one example, when the receiving sensitivity verified by the broadcasting receiving module 143 is a predetermined reference value or less, the service linking processing unit 150 may recognize a current situation as the situation in which the service linking is required In this case, the service linking processing unit 150 may request the geolocation information of the digital radio broadcasting receiving apparatus to the GPS receiving module 141 and request the broadcasting service information such as the frequency information, the ensemble ID information, and the service ID information to the broadcasting receiving module 143.

The service linking processing unit 150 configures a message including the geolocation data provided from the GPS receiving module 141 and the broadcasting service information provided from the broadcasting receiving module 143. In this case, the service linking processing unit 150 transmits the configured message to the service linking providing server through the communication module 145 to request the location of the digital radio broadcasting receiving apparatus and the service linking information corresponding to the broadcasting service which is currently received. Herein, the service linking processing unit 150 may request information on a broadcasting service which is the same as or similar to the broadcasting service which is currently received.

In this case, the service linking providing server may verify the geolocation data and the broadcasting service information of the digital radio broadcasting receiving apparatus from the message received through the communication module 145 and provide to the digital radio broadcasting apparatus the service linking information corresponding to the broadcasting service information based on the verified location.

Herein, the service linking providing server searches information on the broadcasting server that provides the broadcasting service which is the same as or similar to the corresponding broadcasting service among broadcasting servers in the broadcasting network providing a broadcasting service such as DAB, AM FM, DRM, or HD-Radio based on the geolocation data and the broadcasting service information of the digital radio broadcasting receiving apparatus to provide the service linking information for the searched broadcasting server to the digital radio broadcasting receiving apparatus. The service linking information provided from the service linking providing server may include the frequency information, the ensemble ID information, and the service ID information of the broadcasting service which may be linked with the broadcasting service which is currently received.

In this case, the service linking providing server may provide information on the same or similar broadcasting service provided through another service channel within the same frequency as the broadcasting service which is currently received and provide information on a broadcasting service which may be linked with the broadcasting service which is currently received among broadcasting services provided from a broadcasting signal at a frequency different from the corresponding broadcasting service.

The service linking processing unit 150 may transfer the service linking information received through the communication module 145, that is, the frequency information, the ensemble ID information, and the service ID information to the broadcasting receiving module 143. In this case, the broadcasting receiving module 143 may tune a frequency based on the frequency information transferred from the service linking processing unit 150 and receive the broadcasting signal of a channel corresponding to the service ID information from a broadcasting server corresponding to the ensemble ID information.

Meanwhile, the digital radio broadcasting receiving apparatus according to the present invention may further include a storing unit 160. The storage unit 160 may store data required for operating the digital radio broadcasting receiving apparatus. As one example, the storage unit 160 may store the geolocation data received through the GPS receiving module 141 and store the information on the broadcasting signal and the broadcasting service information received through the broadcasting receiving module 143. Further, the storage unit 160 may store session information between the communication module 145 and the service linking providing server, and the like. The storage unit 160 may store reference value information for the receiving sensitivity of the broadcasting signal and store an algorithm to perform service linking processing of the broadcasting service of the digital radio broadcasting receiving apparatus.

Further, the storage unit 160 may include a service linking information database. Herein, when communication connection with the service linking providing server through the communication module 145 is difficult, the service linking information database may extract the service linking information corresponding to the broadcasting service and provide the extracted service linking information to the service linking processing unit 150.

However, under an environment in which the communication connection with the service linking providing server through the communication module 145 is possible, the service linking information database may not be included in the storage unit 160.

Herein, the storage unit 160 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

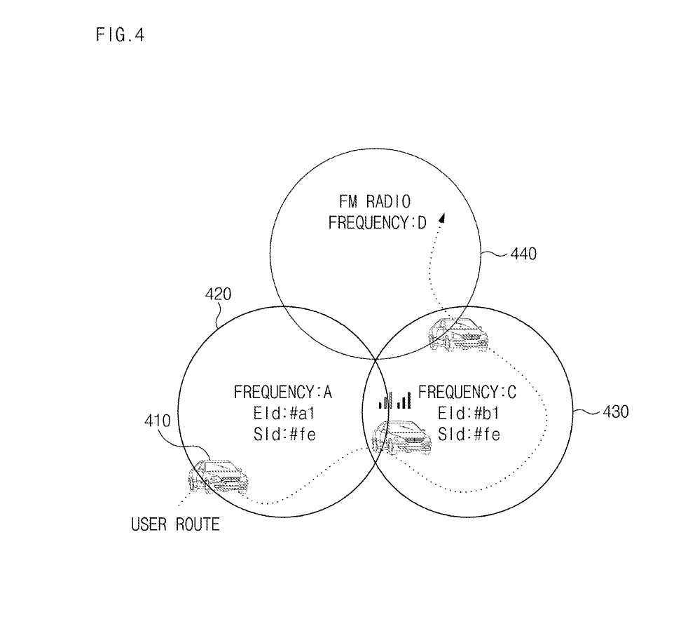

FIG. 4 is a diagram illustrating a broadcasting network structure applied to the present invention.

The digital radio broadcasting receiving apparatus according to the present invention provides linkage (following) services for the digital radio broadcasting service and in this case, the service linking means a service of a type which continuously provides the same service or similar service transmitted from an adjacent broadcasting network in the broadcasting network when a service to which a listener which is moving currently listens is not good and it is difficult to receive the broadcasting any longer.

As illustrated in FIG. 4, when the user listens to the broadcasting through the digital radio broadcasting receiving apparatus, in the case where a vehicle 410 in which the corresponding user rides deviates from a boundary of coverage 420 of broadcasting server A to move to coverage 430 of another broadcasting server B or in the case where the vehicle 410 deviates from the boundary of the coverage 430 of the broadcasting server B to move to coverage 440 of another broadcasting server D, the broadcasting receiving sensitivity is weakened or a broadcasting capability deteriorates. In this case, the digital radio broadcasting receiving apparatus may automatically request the service linking information for the broadcasting service which is currently received without a separate operation of the user and automatically provide the linked broadcasting service by receiving information on another broadcasting server providing the same or similar broadcasting service from the service linking providing server.

Herein, the service linking information may be provided based on the frequency information, the ensemble ID information, and the service ID information. As one example, when as the information on the broadcasting service to which the user currently listens, “the frequency is A, the ensemble ID information (EId) is #a1, and the service ID information (Sid) is #fe”, as the service linking information for the corresponding broadcasting service, “the frequency: C, the ensemble ID information (EId): #b1, and the service ID information (Sid): #fe” may be received from the service linking providing server. In this case, it may be verified that the broadcasting servers are different from each other, but the broadcasting services provided by the corresponding broadcasting servers may be the same as each other.

Therefore, the digital radio broadcasting receiving apparatus may provide to the user the broadcasting service of a neighbor broadcasting server based on the received service linking information “the frequency: C, the ensemble ID information (EId): #b1, and the service ID information (Sid): #fe”.

The service linking providing server may provide the service linking information for the broadcasting service of a broadcasting server having the same frequency and ensemble ID but having a different service ID, the broadcasting service having the same service ID provided from a different ensemble which is irrespective of a different frequency, the broadcasting service having the same ensemble ID and the same service ID broadcasted at a different frequency, and the like. Further, the service linking providing server may provide the same service transmitted from a digital radio mondiale (DRM) broadcasting signal which is another digital broadcasting standard or the service linking information through an FM channel which is an analog scheme.

To this end, the digital radio broadcasting receiving apparatus and the service linking providing server may define fast information groups (FIG) through a fast information channel (FIC) for the DAB with respect to transmitted/received data and load the service linking information on each group and transmit the service linking information.

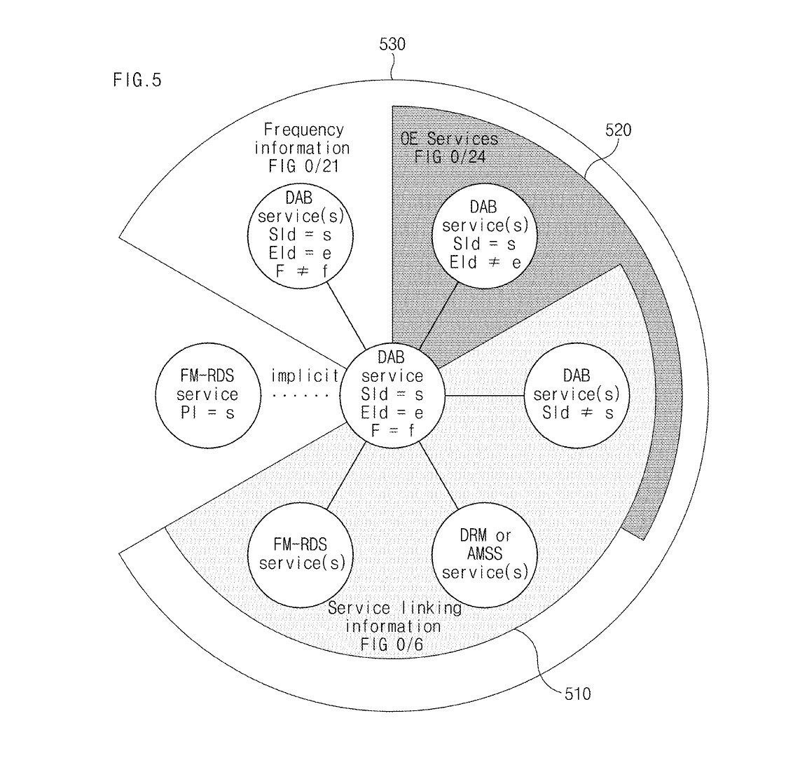

As one example, FIG 0/6 (FIG type 0 extension 6) 510, FIG 0/24 (FIG type 0 extension 24) 520, and FIG 0/21 (FIG type 0 extension 21) 530 may correspond to the fast information groups (FIG) as illustrated in FIG. 5.

Herein, service linking information for affiliating the service may be defined in the FIG 0/6 510 and an identifier of the linked service and a code field for managing the identifier may be included in the service linking information.

Further, information on adjacent other ensembles service, that is, information on an adjacent radio broadcasting network may be defined in the FIG 0/24 520 and other ensembles information defined in the FIG 0/24 520 enables the ensemble including the linked service identifier defined in the FIG 0/6 510 to be identified. In addition the frequency information may be defined in FIG 0/21 530 and the service following may be performed to the linked broadcasting network through the defined frequency information.

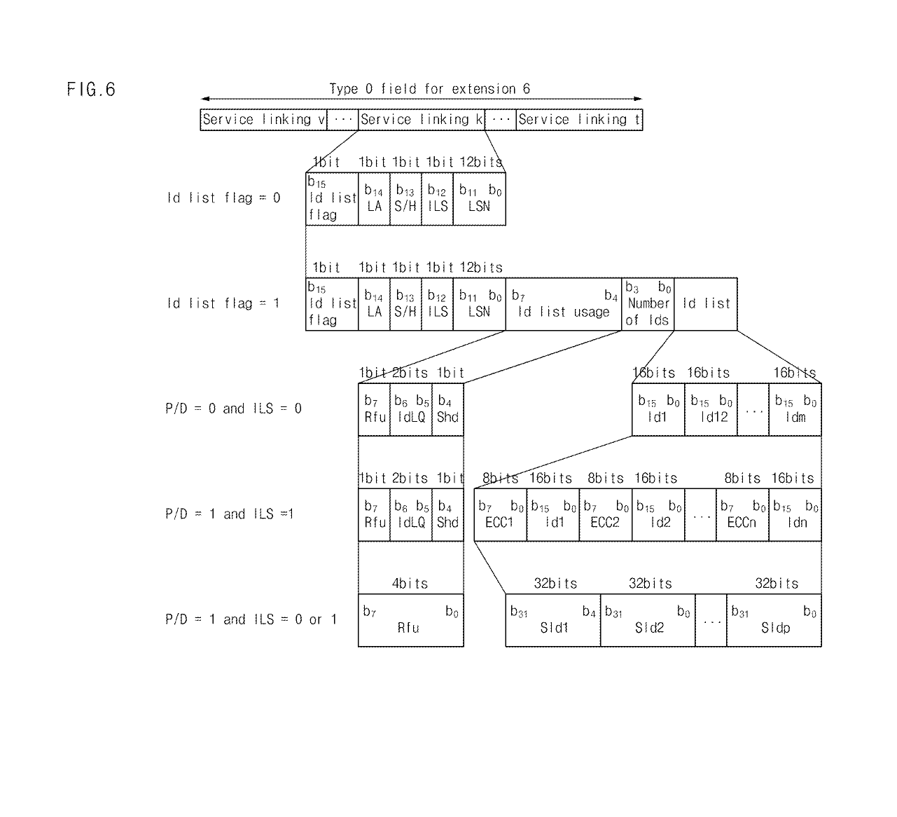

Data defined in the fast information groups (FIG) may be implemented in a data structure illustrated in FIGS. 6 to 8.

First, FIG. 6 is a diagram illustrating an exemplary embodiment referred for describing a data structure of service linking information according to the present invention.

As illustrated in FIG. 6, the service linking information is configured in a FIG 0/6 (FIG type 0 extension 6) data format to be encoded. The service linking information is implemented as one data group through consecutive configuration of one or more service linking information. Each service linking information may be configured in a short form or a long form for updating a related database.

Herein, the short form announces that the database is changed and a configuration of the related database may be changed by recognizing the short form. In this case, the short form is set as “Id list flag=0”.

The long form includes a list of service identifiers linked with each other and is set as “Id list flag=1”. The list of the service identifiers linked with each other may include a service identifier internationally applied like Europe and include a service identifier limited to a specific nation. Further, in the list of the service identifiers, an audio service and service linking information for data services linked with each other may be clearly stated. The data structure of the service linking information illustrated in FIG. 6 follows an EN 300 401 standard.

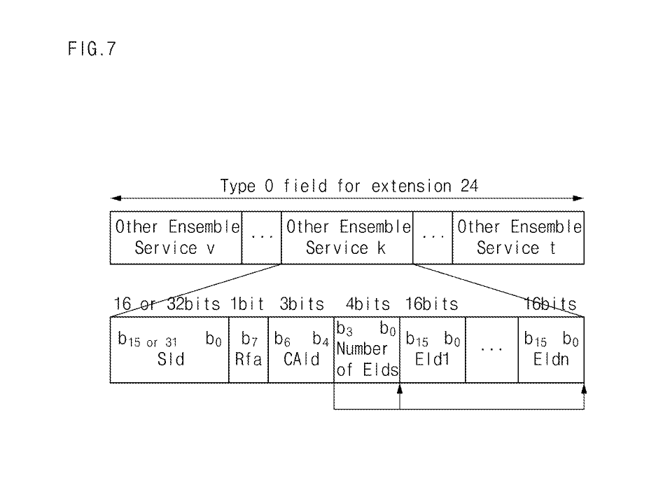

FIG. 7 is a diagram illustrating an exemplary embodiment referred for describing a data structure of another ensemble information according to the present invention.

As illustrated in FIG. 7, the other ensemble information may be configured in a FIG 0/24 data format. A FIG 0/24 structure includes an ensemble identifier for other adjacent ensemble linked with a specific service in a current ensemble. The FIG 0/24 structure may be configured in the short form and the long form for changing the database similarly to the FIG 0/6 structure.

In this case, the short form announces that the database is changed and is set to “Number of EIds=0”.

Meanwhile, the long form as a field configuration including other ensemble information may include other ensemble identifies linked with the corresponding service identifier.

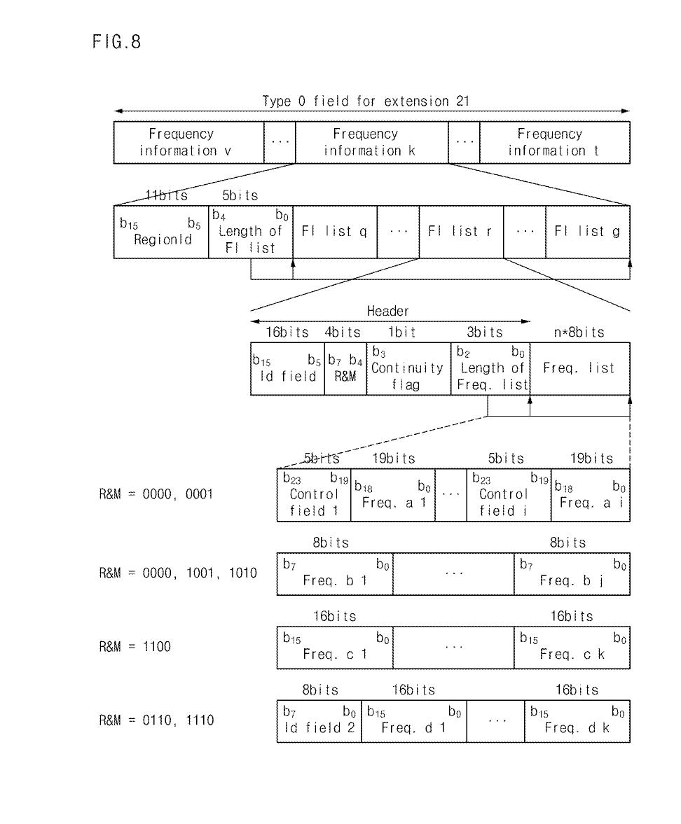

FIG. 8 is a diagram illustrating an exemplary embodiment referred for describing a data structure of frequency information according to the present invention.

As illustrated in FIG. 8, the frequency information may be configured in a FIG 0/21 data format. A FIG 0/21 structure may include an adjacent ensemble associated with a digital radio broadcasting frequency which is currently received or frequency information of AM/FM.

The FIG 0/21 structure may classify a type of an identifier (ID), for example, an ensemble identifier, a DRM service identifier, an RDS-PI code, and an AMSS service identifier according to a range and modulation (R&M) field and may include frequencies for the corresponding identifiers.

As described above, the digital radio broadcasting receiving apparatus verifies the service linking information through FIG 0/6, FIG 0/24, and FIG 0/21 to receive the service which is the same as or similar to the broadcasting service which is a currently received. In other words, when a state of the currently received service is not excellent, the digital radio broadcasting receiving apparatus may determine service information to be followed through the service linking information configured through FIG 0/6 and verify other ensemble information clearly stated in FIG 0/24 when there is a service which will be linked to other adjacent ensemble. In this case, received frequency information for the other adjacent ensemble may be verified through FIG 0/21.

Therefore, the digital radio broadcasting receiving apparatus may provide the tune the determined frequency and thereafter, provides service following by receiving the linked service.

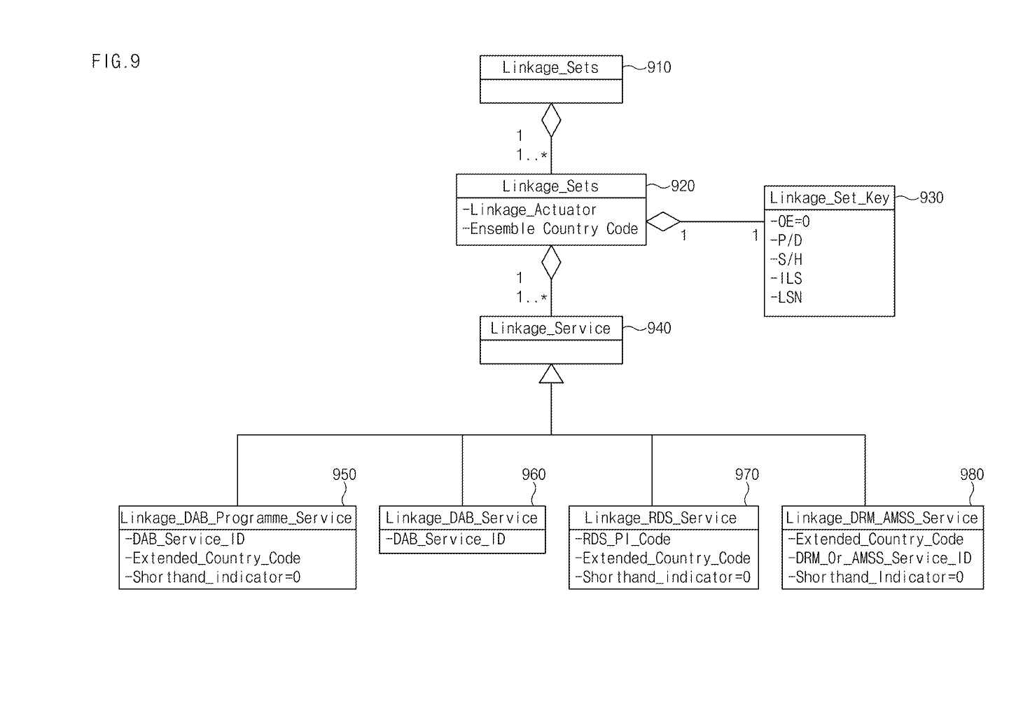

The service linking information, the other ensemble services information, and the frequency information are built up as the database as illustrated in FIG. 9 and the service linking information corresponding to specific broadcasting service may be extracted from the database.

FIG. 9 is a diagram illustrating a database of service linking information proposed as an exemplary embodiment in a DAB standard and the service linking information may be constituted by linkage_sets 910 and the linkage_sets 910 may be constituted by one or more linkage_sets 920, respectively. In this case, each linkage_set 920 may be identified by linkage_set_key 930. Herein, the linkage_set_key 930 may be constituted by a combination of Other Ensemble (OE), Program/Data (P/D), Soft/Hard (S/H), International linkage set indicator (ILS), and Linkage set Number (LSN) provided from the service linking information. Further, each linkage_set 920 has one or more linked services (linked_service) 940 and the linked service 940 may have at least one Linked_DAB_Programme_Service 950, Linked_DAB_Data_Service 960, Linked_RDS_Service 970, and Linked_DRM_AMSS_Service 980.

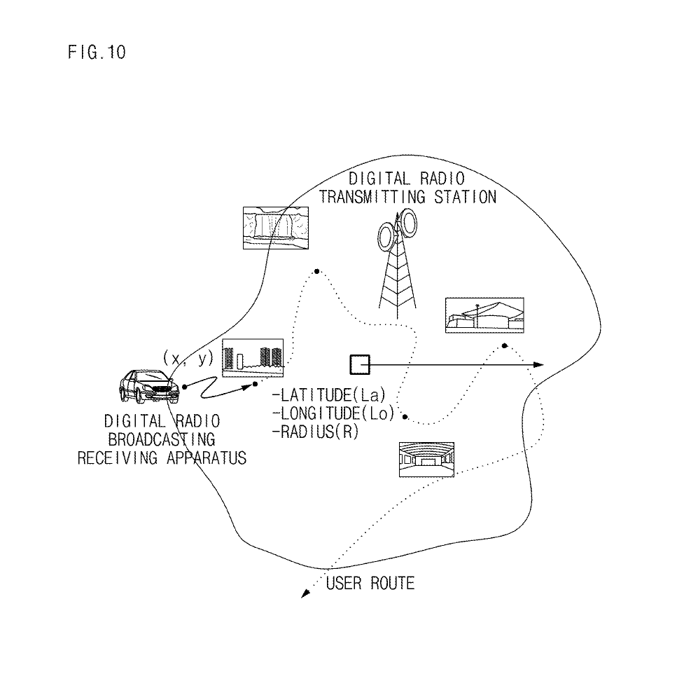

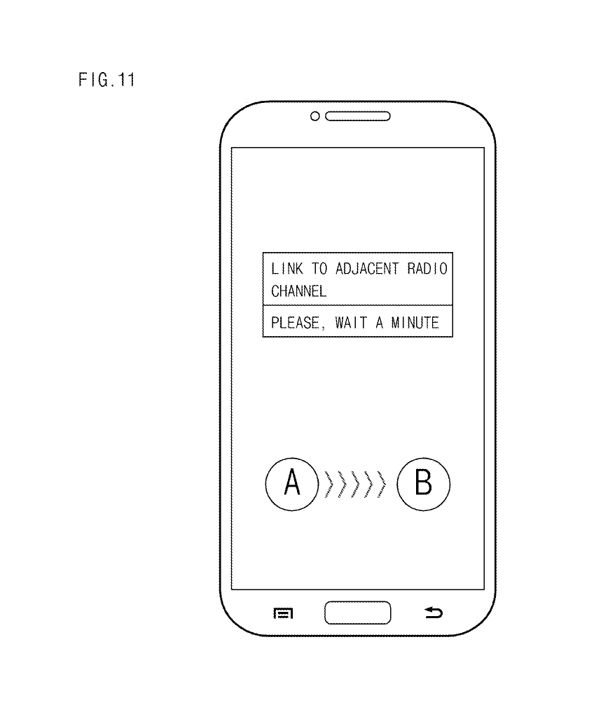

FIGS. 10 and 11 are diagrams illustrating an exemplary embodiment referred for describing an operation of the apparatus for receiving digital radio broadcasting according to the present invention.

The respective coverage of broadcasting network may have a circular shape having the same range, but the coverage may have an arbitrary shape illustrated in FIG. 10. In the case of a receiver provided in the vehicle, the digital radio broadcasting receiving apparatus may rapidly move within the coverage of the broadcasting servers and when the digital radio broadcasting receiving apparatus deviates from the coverage supported by the broadcasting server, the service linking information is received from the service linking providing server according to the location of the digital radio broadcasting receiving apparatus and the information on the broadcasting service which is received to continuously receive a broadcasting service of an adjacent broadcasting network.

In this case, when the digital radio broadcasting receiving apparatus changes the broadcasting service which is received to the broadcasting service provided by the adjacent broadcasting network, change information of the broadcasting service may be guided to the user through the display as illustrated in FIG. 11.

Of course, in FIG. 11, an example in which the operating status of service following of the broadcasting service is guided through the display is illustrated, but the operating status of service following may be guided by the voice through a speaker.

An operational flow of the digital radio broadcasting receiving apparatus according to the present invention, which is configured as above will be described below in more detail.

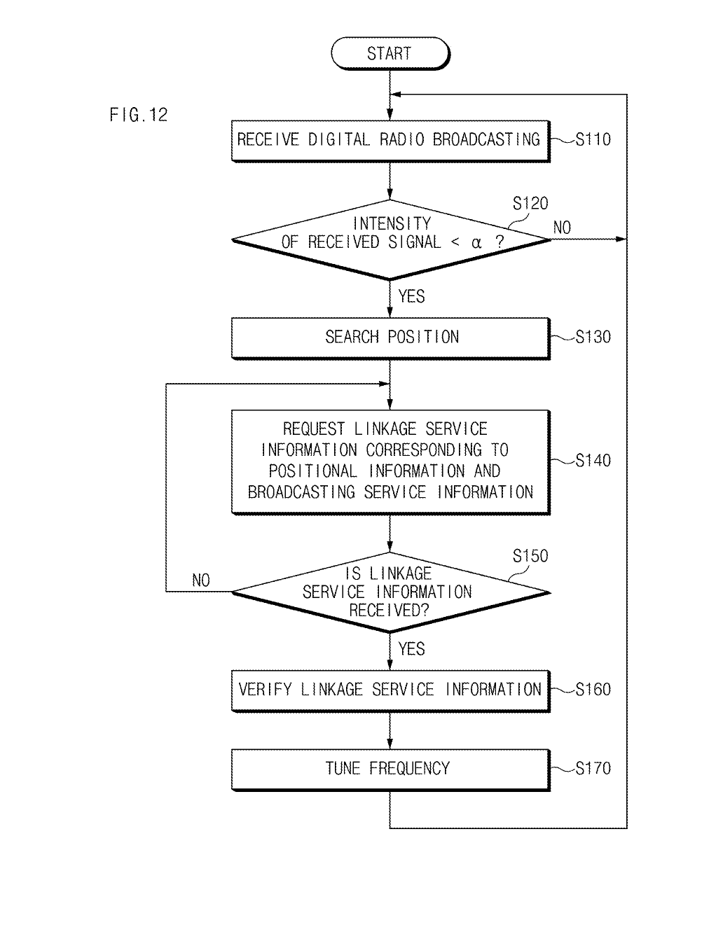

FIG. 12 is a diagram illustrating an operational flow for a method for receiving digital radio broadcasting according to the present invention. Referring to FIG. 12, when the intensity of a received signal decreases to a value less than a predetermined reference value while the digital radio broadcasting receiving apparatus according to the present invention receives the digital radio broadcasting (S110 and S120), the digital radio broadcasting receiving apparatus searches a current location of the digital radio broadcasting receiving apparatus through the GPS receiving module (S130).

Thereafter, the digital radio broadcasting receiving apparatus requests the service linking information corresponding to the geolocation information searched during process ‘S130’ and the broadcasting service information received during process ‘S110’ to the service linking providing server (S140).

When the service linking information is received from the service linking providing server (S150), the received service linking information is verified (S160). As one example, the digital radio broadcasting receiving apparatus verifies the frequency information, the ensemble ID information, and the service ID information based on the service linking information which is received during process ‘S150’.

The digital radio broadcasting receiving apparatus tunes the frequency based on the frequency information verified from the service linking information (S170) and receives the digital radio broadcasting corresponding thereto (S110).

Processes ‘S110’ to ‘S170’ may be repeatedly performed until the operation of the digital radio broadcasting receiving apparatus ends.

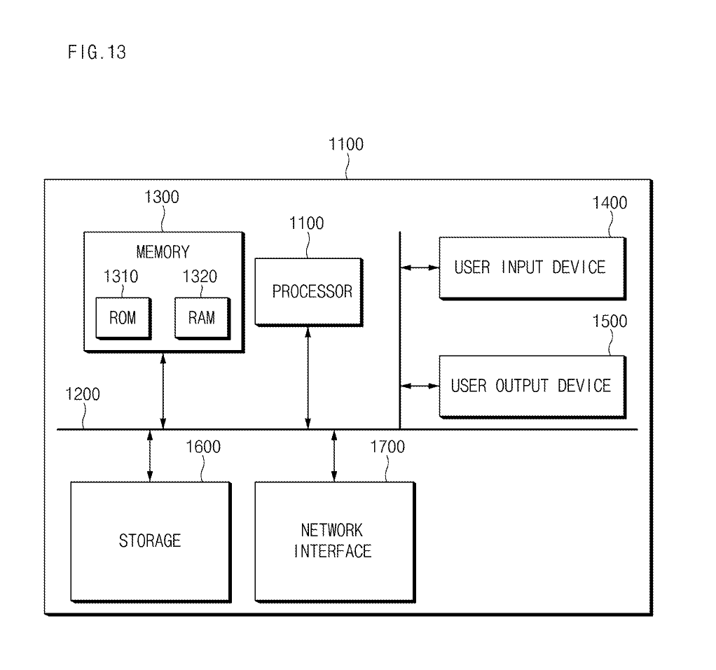

FIG. 13 is a diagram illustrating a computing system to which the apparatus according to the present invention is applied.

Referring to FIG. 13, the computing system 1000 may include at least one processor 1100, a memory 1300, a user interface input device 1400, a user interface output device 1500, a storage 1600, and a network interface 1700 connected through a bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

The above description just illustrates the technical spirit of the present invention and various changes and modifications can be made by those skilled in the art to which the present invention pertains without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. An apparatus for receiving digital radio broadcasting, the apparatus comprising:
a communication unit including a GPS receiving module receiving geolocation information from a GPS satellite network and a broadcasting receiving module receiving a broadcasting signal transmitted from a broadcasting network;
an output unit receiving and outputting the broadcasting signal through the broadcasting receiving module; and
a service linking processing unit requesting service linking information based on current geolocation information received through the GPS receiving module and broadcasting service information included in the broadcasting signal when a receiving sensitivity of the broadcasting signal which is currently received is less than a predetermined reference value and performing service following based on the service linking information provided from a service linking providing server based on the current geolocation information,
wherein the service linking information includes information on the same broadcasting service as a broadcasting service which is currently received.

2. The apparatus of claim 1, wherein the service linking information includes information on the same or similar broadcasting service provided through another service channel within the same frequency as the broadcasting service which is currently received.

3. The apparatus of claim 1, wherein the service linking information includes information on a broadcasting service which is linkable with the broadcasting service which is currently received among broadcasting services provided from a broadcasting signal having a different frequency from the corresponding broadcasting service.

4. The apparatus of claim 1, wherein the service linking information includes at least one of frequency information, ensemble identification information, and service identification information of the corresponding broadcasting service.

5. The apparatus of claim 1, wherein the service linking information is defined in fast information groups (FIG) of a fast information channel (FIC) for digital audio broadcasting (DAB).

6. The apparatus of claim 1, wherein the communication unit further includes a communication module transmitting/receiving a signal to/from the service linking providing server through a mobile communication network.

7. The apparatus of claim 1, wherein the service linking providing server builds up a database for information on the respective broadcasting services provided from the broadcasting network and searches information on a broadcasting service corresponding to the broadcasting service which is currently received from the database based on the geolocation information provided from the service linking processing unit.

8. The apparatus of claim 7, wherein the service linking providing server searches service linking information having a highest signal level at a corresponding location among linkage information of the corresponding broadcasting service registered in the database based on the current geolocation information and the broadcasting service information of the digital radio broadcasting receiving apparatus.

9. The apparatus of claim 1, further comprising:
a storage unit storing the service linking information.

10. The apparatus of claim 9, wherein the service linking processing unit performs the service following based on the service linking information stored in the storage unit when communication connection to the service linking providing server is impossible.

11. A method for receiving digital radio broadcasting, the method comprising:
receiving a broadcasting signal through a broadcasting receiving module;
requesting service linking information to a service linking providing server through a communication module based on current geolocation information received through a GPS receiving module and broadcasting service information included in the broadcasting signal when a receiving sensitivity of the broadcasting signal which is currently received is less than a predetermined reference value;
receiving the service linking information corresponding to a broadcasting service which is currently received based on the current geolocation information from the service linking providing server; and
performing service following based on the received service linking information,
wherein the service linking information includes information on a broadcasting service which is linkable to correspond to the broadcasting service which is currently received.

12. The method of claim 11, wherein the service linking information includes information on the same or similar broadcasting service provided through another service channel within the same frequency as the broadcasting service which is currently received.

13. The method of claim 11, wherein the service linking information includes information on a broadcasting service which is linkable with the broadcasting service which is currently received among broadcasting services provided from a broadcasting signal having a different frequency from the corresponding broadcasting service.

14. The method of claim 11, further comprising:
by the service linking providing server,
building up a database for information on respective broadcasting services provided from a broadcasting network; and
searching service linking information having a highest signal level based on a corresponding location among linkage information of the corresponding broadcasting service registered in the database based on the current geolocation information and the broadcasting service information of the digital radio broadcasting receiving apparatus, which are received through a communication module.

15. The method of claim 11, further comprising:
storing the service linking information before the receiving of the broadcasting signal.

16. The method of claim 15, wherein in the performing of the service following, when communication connection to the service linking providing server is impossible, the service following is performed based on the service linking information stored in the storing of the service linking information.
